(19) United States
(12) Patent Application Publication
(10) Pub. No.: US 2013/0037487 A1
(43) Pub. Date: Feb. 14, 2013

(54) POLY (SULFOAMINOANTHRAQUINONE) MATERIALS AND METHODS FOR THEIR PREPARATION AND USE

(71) Applicants: Mei-rong Huang, Shanghai (CN); Shao-Jun Huang, Shanghai (CN); Xin-gui Li, Shanghai (CN)

(72) Inventors: Mei-rong Huang, Shanghai (CN); Shao-Jun Huang, Shanghai (CN); Xin-gui Li, Shanghai (CN)

(73) Assignee: TONGJI UNIVERSITY, Shanghai (CN)

(21) Appl. No.: 13/265,272

(22) PCT Filed: Feb. 25, 2011
(86) PCT No.: PCT/CN11/71316

§ 371 Date: Oct. 31, 2012

(51) Int. Cl. C02F 1/62; C02F 1/28; C08G 73/02; B82Y 30/00

(52) U.S. Cl. 210/681; 528/220; 428/402; 977/773

(57) ABSTRACT

Poly(sulfoaminoanthraquinone) polymer compositions and methods of making these compositions are disclosed herein. The polymer compositions can, for example, be used for removing metal ions from a sample.

### BACKGROUND

1. Field

The present application relates to compositions and methods for removal of metal ions from a sample.

2. Description of the Related Art

Cost-effective methods for removing heavy metal ions from wastewater remains a challenge for environmental protection. Some available adsorbents have limited capacity and/or adsorption rates because they lack polyfunctional groups and/or a large surface area. For example, activated carbon can have a high surface area but rarely have adsorbing functional groups. Chelating resins typically include polyfunctional groups, e.g., O, N, S, and P donor atoms, which can coordinate to different metal ions; however, their small specific area and low adsorption rate limit their application. There is a need for potent adsorbents that remove metal ions from a sample.

### SUMMARY

Some embodiments disclosed herein include a polymer having at least one monomer unit selected from the group consisting of a first monomer unit represented by Formula I, a second monomer unit represented by Formula II, and a third monomer unit represented by Formula III:

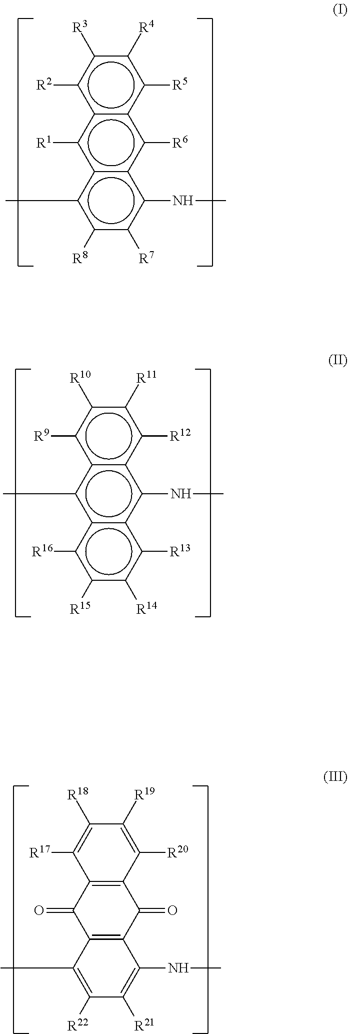

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K.

In some embodiments, R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, and —SO₃H. In some embodiments, R⁹ and R¹⁰ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, and —SO₃H. In some embodiments, the halogen is —Cl or —Br. In some embodiments, R¹ and R⁶ are each ═O. In some embodiments, R⁷ and R¹⁰ are each independently —NH₂ or hydrogen. In some embodiments, R³, R⁴ and R⁵ are each hydrogen. In some embodiments, R⁹ is hydrogen. In some embodiments, R² and R⁸ are each independently selected from the group consisting of hydrogen, —SO₃NH₄, —SO₃Na, —SO₃K and —SO₃H.

In some embodiments, the monomer unit is selected from the group consisting of

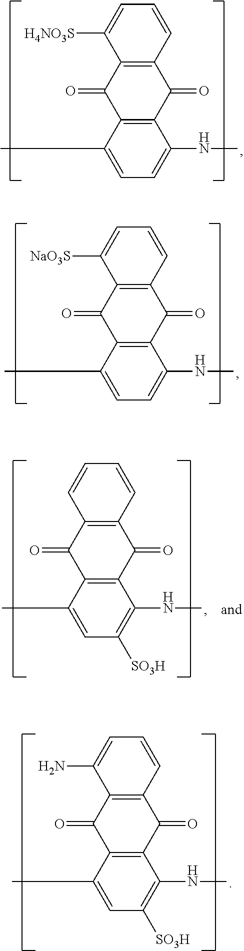

In some embodiments, the monomer unit is

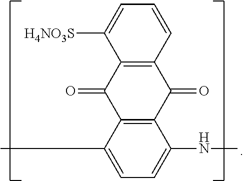

In some embodiments, R¹ and R⁶ are each independently —NH₂ or hydrogen.

Some embodiments disclosed herein include a composition comprising nanoparticles, wherein the nanoparticles comprise a polymer comprising at least one monomer unit selected from the group consisting of a first monomer unit represented by Formula I, a second monomer unit represented by Formula II, and a third monomer unit represented by Formula III:

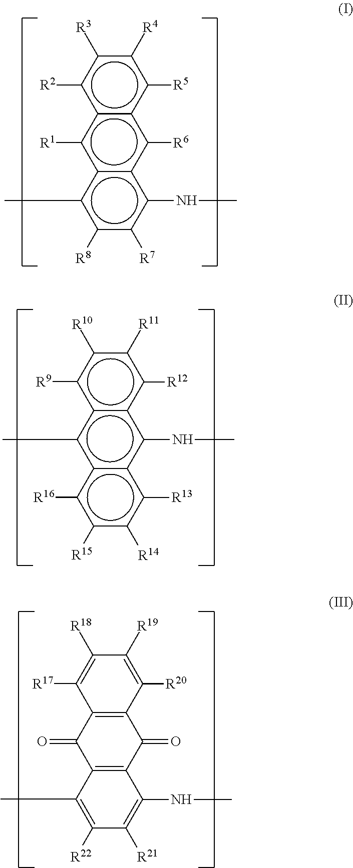

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K.

In some embodiments, the nanoparticles have a size of about 20 nm to about 200 nm. In some embodiments, the nanoparticles have a pour density of about 0.2 g/cm³ to about 1.0 g/cm³. In some embodiments, the nanoparticles have a bulk density of about 0.3 g/cm³ to about 1.0 g/cm³. In some embodiments, the nanoparticles have an average BET specific area of about 15 m²/g to about 1000 m²/g. In some embodiments, the nanoparticles have an average pore diameter of about 10 nm to about 50 nm.

Some embodiments disclosed herein include a method of making a polymer, the method comprising: forming a composition comprising at least one oxidizing agent and at least one monomer represented by a structure selected from the group consisting of Formula IV, Formula V and Formula VI:

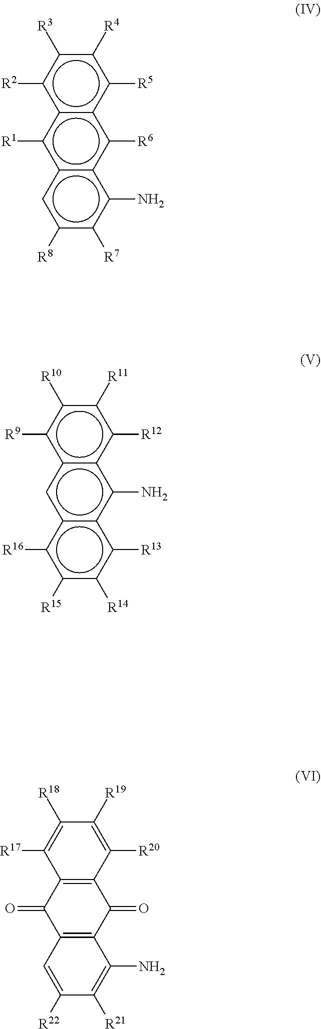

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R¹, R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K;

and maintaining the composition under conditions effective to polymerize the monomer to form the polymer.

In some embodiments, the monomer is selected from the group consisting of 5-sulfo-1-aminoanthraquinone (SA), 1-aminoanthraquinone-5-sulphonic acid sodium salt, 1-aminoanthraquinone-2-sulphonic acid, 1,5-diaminoanthraquinone-2-sulphonic acid, and combinations thereof. In some embodiments, the oxidizing agent is soluble in water. In some embodiments, the oxidizing agent is CrO₃, K₂Cr₂O₇, K₂CrO₄, or any combination thereof.

Some embodiments disclosed herein include a method for removing metal ions from a sample, the method comprising: providing an untreated sample suspected of containing one or more metal ions; and contacting the sample and a composition to form a treated sample, wherein the composition comprises a polymer comprising a monomer unit represented by a formula selected from Formula I, Formula II and Formula III:

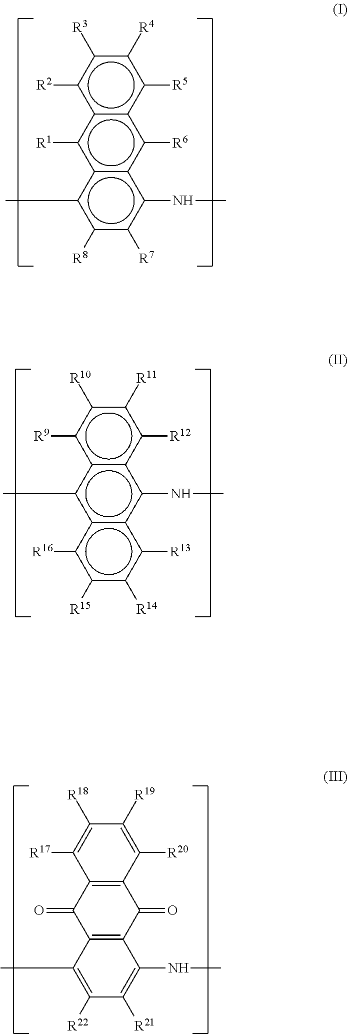

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K.

In some embodiments, the monomer unit is selected from the group consisting of

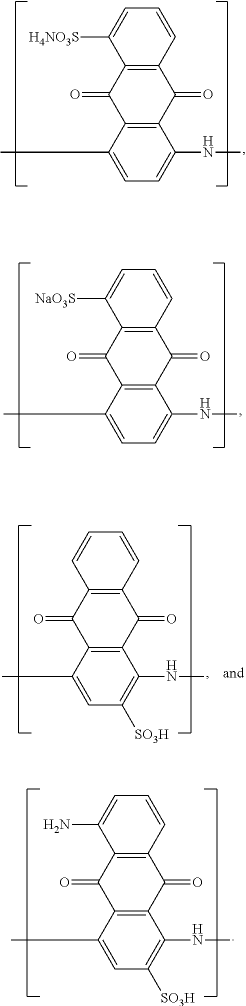

In some embodiments, the monomer unit is

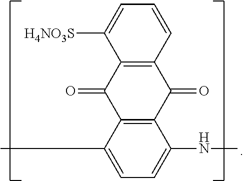

In some embodiments, the metal ion is a heavy metal ion. In some embodiments, the heavy metal ion is selected from the group consisting of As(III), As(V), Cd(II), Cr(VI), Pb(II), Hg(II), Sb(III), Sb(V), Ni(II), Ag(I) and Tl(III).

In some embodiments, the metal ion is a noble metal ion. In some embodiments, the noble metal ion is selected from the group consisting of Ag(I), Au(I), Au(III), Pt(II), Pt(IV), Ir(III), Ir(IV), Ir(VI), Pd(II) and Pd(IV).

In some embodiments, the untreated sample is wastewater. In some embodiments, the concentration of the metal ion in the untreated sample is no more than about 5 g/L. In some embodiments, the concentration of the metal ion is from about 0.01 mg/L to about 1 g/L.

In some embodiments, the untreated sample has a higher concentration of the metal ion than the treated sample. In some embodiments, the concentration of the metal ion in the untreated sample is at least about 5 times higher than the concentration of the metal ion in the treated sample. In some embodiments, the concentration of the metal ion in the untreated sample is at least about 10 times higher than the concentration of the metal ion in the treated sample. In some embodiments, the concentration of the metal ion in the untreated sample is at least about 20 times higher than the concentration of the metal ion in the treated sample. In some embodiments, the concentration of the metal ion in the treated sample is less than about 20% of the concentration of the metal ion in the untreated sample. In some embodiments, the concentration of the metal ion in the treated sample is less than about 5% of the concentration of the metal ion in the untreated sample. In some embodiments, the concentration of the metal ion in the treated sample is less than about 1% of the concentration of the metal ion in the untreated sample

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 shows differential scanning calorimetry (DSC), thermogravimetric (TG) and differential thermogravimetric (DTG) curves in air for the PSA polymers prepared with various oxidants.

FIG. 2 shows size distribution curves of PSA polymer particles (dispersed in water) prepared with various oxidants.

FIG. 3 shows nitrogen adsorption-desorption isotherms and pore size distribution curves (inset) of fine PSA polymer powders synthesized with K₂CrO₄ as oxidant.

FIG. 4 shows the synthetic yield and bulk electrical conductivity of PSA polymers synthesized under various polymerization conditions.

FIG. 5 shows the UV-vis absorption spectra of SA monomers and PSA polymers prepared under various polymerization conditions

FIG. 6 shows the adsorption kinetics of (a) Pb(II) and (b) Hg(II) ions onto PSA polymers. The inset shows kinetics model plots of the adsorption of Pb(II) and Hg(II) onto the PSA polymers.

FIG. 7 shows the IR spectra for monomeric SA and the PSA polymers (before and after adsorbing Pb(II) and Hg(II) ions).

FIG. 8 shows a wide-angle X-ray diffractogram for SA monomers and PSA polymers (before and after adsorption of Pb(II) and Hg(II) ions).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Disclosed herein are polymers having at least one monomer unit represented by a formula selected from Formula I, Formula II and Formula III:

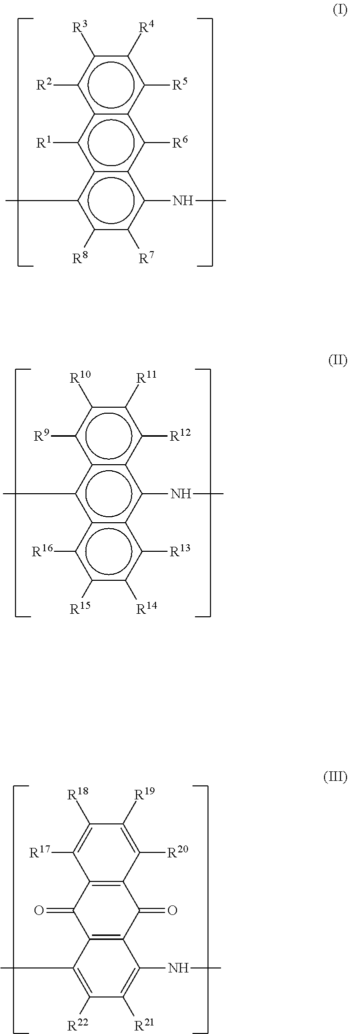

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K.

The polymer may be used, for example, removing metal ions from a sample. Also disclosed herein are methods of making the polymer. The methods can, in some embodiments, include standard polymerization procedures that may be easily scaled for manufacturing purposes. The present application also includes methods of using the polymer.

### DEFINITIONS

As used herein, “halogen” means any one of the radio-stable atoms of column 7 of the Periodic Table of the Elements, such as, fluorine, chlorine, bromine and iodine.

As used herein, “alkyl” refers to a straight or branched hydrocarbon chain that comprises a fully saturated (no double or triple bonds) hydrocarbon group. The alkyl group of the compounds may be designated as “C₁-C₄ alkyl” or similar designations. By way of example only, “C₁-C₄ alkyl” indicates that there are one to four carbon atoms in the alkyl chain, i.e., the alkyl chain is selected from methyl, ethyl, propyl, iso-propyl, n-butyl, iso-butyl, sec-butyl, and tert-butyl. Typical alkyl groups include, but are in no way limited to, methyl, ethyl, propyl, isopropyl, butyl, isobutyl, tertiary butyl, pentyl, hexyl, and the like. The alkyl group may be substituted or unsubstituted.

As used herein, “apparent density” refers to the ratio of the mass of a substance to a given volume. For the determination, the substance is put into a receiver of known dimensions and weight.

As used herein, “bulk density” is a measure of the weight of solids, such as powders and granules, per unit volume. Bulk density is determined as the mass of a substance divided by the total volume they occupy. The total volume can include particle volume, inter-particle void volume and internal pore volume.

As used herein, “pour density” is a measurement of the mass per unit volume of a material including voids inherent in the materials and spaces between particle materials when the materials are in a natural (loose) state. The pour density can be calculated as equal to m/V=m/(V₀+Vᵢ+Vₛ); where m=mass of particle materials, V₀=volume of particle materials themselves, Vᵢ=volume of voids inherent in the particle materials, and Vₛ=volume of spaces between particle materials.

As used herein, “bulk density” is a measurement of the mass per unit volume of particles. Particles can be placed in a container and stacked tightly by application of a force sufficient to minimize the volume of spaces between particle materials (essentially making Vₛ from the pour density formula equal to zero). The bulk density can be calculated as equal to m/(V₀+Vᵢ); where m=mass of particle materials, V₀=volume of particle materials themselves, and Vᵢ=volume of voids inherent in the particle materials.

As used herein, “BET specific surface area” refers to the specific surface area of a material that is measured by nitrogen multilayer adsorption measured as a function of relative pressure. Analyzers and testing services are commercially available from various sources including CERAM (Staffordshire, UK).

### Poly(Sulfoaminoanthraquinone) Materials

Some embodiments disclosed herein include polymers having at least one monomer unit represented a formula selected from by Formula I, Formula II and Formula III:

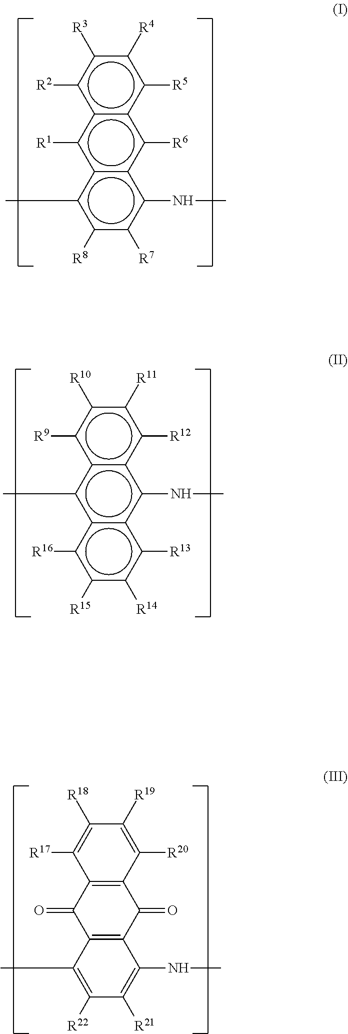

wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;

wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;

wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;

wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;

wherein at least one of R¹⁷, R¹⁸, R¹⁹, R²⁰, R²¹, and R²² is X;

wherein each X is independently selected from the group consisting of —SO₃H, —SO₃NH₄, —SO₃Na, and —SO₃K.

In some embodiments, R¹, R², R³, R⁴, R⁵, R⁶, R⁷, and R⁸ are each independently hydrogen, —NH—CH₃, —NH—CH₂CH₃, —NH—OH, —N═O, —N═CH₂, —N(CH₃)₂, —N═CH—CH₃, —N═NH, —NH₂, ═O, or —SO₃H. In some embodiments, the halogen is —Cl or —Br. In some embodiments, R¹ and R⁶ are each ═O. In some embodiments, R⁷ is —NH₂ or hydrogen. In some embodiments, R¹⁰ is —NH₂ or hydrogen. In some embodiments, R³, R⁴ and R⁵ are each hydrogen. In some embodiments, R² and R⁸ are each independently hydrogen, —NH—CH₃, —NH—CH₂CH₃, —NH—OH, —N═O, —N═CH₂, —N(CH₃)₂, —N═CH—CH₃, —N═NH, —NH₂, ═O, —SO₃NH₄, —SO₃Na, —SO₃K or —SO₃H.

In some embodiments, R⁹, R¹⁰, R¹¹, R¹², R¹³, R¹⁴, R¹⁵, and R¹⁶ are each independently hydrogen, —NH—CH₃, —NH—CH₂CH₃, —NH—OH, —N═O, —N═CH2, —N(CH₃)₂, —N═CH—CH₃, —N═NH, —NH₂, ═O, or —SO₃H. In some embodiments, R⁹ and R¹⁰ are each independently hydrogen, —NH—CH₃, —NH—CH₂CH₃, —NH—OH, —N═O, —N═CH₂, —N(CH₃)₂, —N═CH—CH₃, —N═NH, —NH₂, ═O, —SO₃NH₄, —SO₃Na, —SO₃K, or —SO₃H. In some embodiments, the halogen is —Cl or —Br. In some embodiments, R¹⁶ and R¹³ are each ═O. In some embodiments, R¹⁰ is —NH₂ or hydrogen. In some embodiments, R⁹ is hydrogen. In some embodiments, R⁹, R¹⁰, R¹¹, R¹², R¹³, R¹⁴, R¹⁵, and R¹⁶ are each independently hydrogen.

In some embodiments, R¹⁷, R¹⁸, R¹⁹, R²⁰, R²¹, and R²² are each independently hydrogen, —NH—CH₃, —NH—CH₂CH₃, —NH—OH, —N═O, —N═CH2, —N(CH₃)₂, —N═CH—CH₃, —N═NH, —NH₂, ═O, —SO₃NH₄, —SO₃Na, —SO₃K, or —SO₃H. In some embodiments, R¹⁷ and R²¹ are each independently hydrogen, —NH—CH₃, —NH—CH₂CH₃, —NH—OH, —N═O, —N═CH2, —N(CH₃)₂, —N═CH—CH₃, —N═NH, —NH₂, ═O, —SO₃Na, —SO₃K or —SO₃H. In some embodiments, R¹⁷ is —SO₃NH₄. In some embodiments, R¹⁷ is —SO₃Na. In some embodiments, R²¹ is —SO₃H. In some embodiments, R²¹ is —SO₃H and R¹⁷ is —NH₂.

The polymer may, in some embodiments, be a copolymer. The copolymer can be a random polymer or a block polymer. The polymer may, for example, be a copolymer that includes at least two different monomer units that are each independently represented by Formula I, II, or III. The polymer may have one, two, three, four, or more monomer units that are each independently represented by Formula I, II, or III. The polymer can, in some embodiments, include a total amount of monomer units that are each independently represented by Formula I, II, or II. This total amount of monomer units can be, for example, at least about 75% by weight; at least about 80% by weight; at least about 85% by weight; at least about 90% by weight; at least about 95% by weight; at least about 97% by weight; at least about 98% by weight; at least about 99% by weight; or at least about 99.5% by weight. The total amount of any single monomer unit represented by Formula I, II, or II can be, for example, at least about 50% by weight; at least about 60% by weight; at least about 70% by weight; at least about 75% by weight; at least about 80% by weight; at least about 85% by weight; at least about 90% by weight; at least about 95% by weight; at least about 97% by weight; at least about 98% by weight; at least about 99% by weight; or at least about 99.5% by weight. In some embodiments, the polymer is a homopolymer.

It will be appreciated that the polymer may optionally include other monomer units. For example, the polymer could include various aryls or heterocycles, such as aniline, that are polymerized into the polymer. The monomer unit may, in some embodiments, be derived from any monomer that can be oxidatively polymerized with an anthraquinone. The amount of other monomer units can be an effective amount that does not substantially alter the absorption properties of the polymer. The amount of other monomer units in the polymer can be, for example, less than or equal to about 10% by weight; less than equal to about 5% by weight; less than or equal to about 3% by weight; less than or equal to about 2% by weight; less than or equal to about 1% by weight; or less than or equal to about 0.5% by weight.

In some embodiments, the polymer has a molecular weight that is sufficiently high for the polymer to be insoluble in an inorganic solvent, such as water; or in an organic solvent, such as tetrahydrofuran (THF), n-methylpyrrolidone (NMP), and dimethyl sulfoxide (DMSO). The average molecular weight of the polymer can be, for example, at least about 500 Da; at least about 800 Da; at least about 1,000 Da; or at least about 1,500 Da. The average molecular weight of the polymer can be, for example, less than or equal to about 10,000 Da; less than or equal to about 5,000 Da; less than or equal to about 2,500 Da; less than or equal to about 1,000 Da; or less than or equal to about 500 Da. In some embodiments, the average molecular weight of the polymer is about 500 Da to about 1,000 Da.

The polymer may, in some embodiments, exhibit electrical conductivity when doped with an effective amount of dopant. For example, a polymer disclosed herein can exhibit a bulk electrical conductivity of about 1×10⁵ to about 1×10⁻⁹ S·cm⁻¹ when doped with HClO₄. In some embodiments, the polymer exhibits a bulk electrical conductivity of at least about 10⁻⁵ S·cm⁻¹ when doped with an effective amount of dopant. In some embodiments, the polymer exhibits a bulk electrical conductivity of at least about 10⁻⁶ S·cm⁻¹ when doped with an effective amount of dopant. In some embodiments, the polymer exhibits a bulk electrical conductivity of at least about 10⁻⁷ S·cm⁻¹ when doped with an effective amount of dopant. In some embodiments, the polymer exhibits a bulk electrical conductivity of at least about 10⁻⁸ S·cm⁻¹ when doped with an effective amount of dopant. In some embodiments, the polymer exhibits a bulk electrical conductivity of at least about 10⁻⁹ S·cm⁻¹ when doped with an effective amount of dopant. In some embodiments, the polymer exhibits a bulk electrical conductivity of at least about 10⁻¹⁰ S·cm⁻¹ when doped with an effective amount of dopant. Non-limiting examples of dopants include halogenated compounds, such as iodine, bromine, chlorine, iodine trichloride; protonic acids such as sulfuric acid, hydrochloric acid, nitric acid, perchloric acid; Lewis acids, such as aluminum trichloride, ferric trichloride, molybdenum chloride; and organic acids, such acetic acid, trifluoracetic acid, and benzenesulfonic acid. In some embodiments, the dopant is HClO₄, for example 1M HClO₄.

Some embodiments disclosed herein include a composition comprising nanoparticles, wherein the nanoparticles comprise a polymer comprising at least one monomer unit represented a formula selected from by Formula I, Formula II and Formula III:

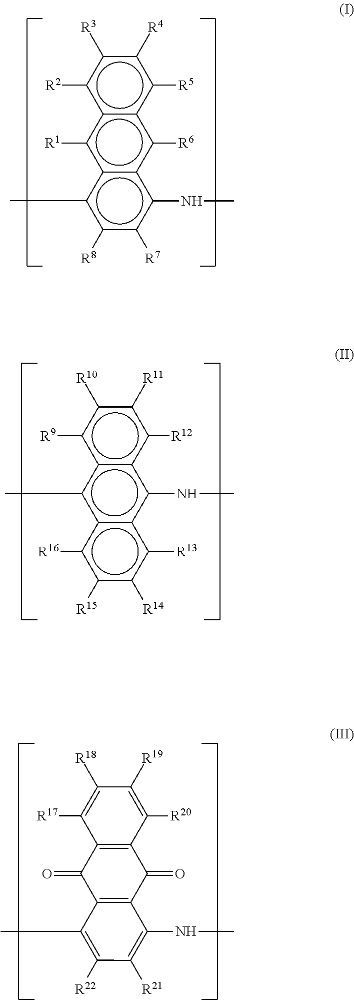

wherein R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, and R²² are as previously defined in the present application.

The nanoparticles can include any of the polymers described in the present application, or combination of two or more of the polymers disclosed herein. The nanoparticles can include at least about 25% by weight of the one or more polymers; at least about 40% by weight of the one or more polymers; at least about 50% by weight of the one or more polymers; at least about 60% by weight of the one or more polymers; at least about 70% by weight of the one or more polymers; at least about 80% by weight of the one or more polymers; at least about 95% by weight of the one or more polymers; at least about 98% by weight of the one or more polymers; or at least about 99% by weight of the one or more polymers.

The composition can, for example, include at least about 0.1% by weight of the nanoparticles; at least about 0.5% by weight of the nanoparticles; at least about 1% by weight of the nanoparticles; at least about 5% by weight of the polymer; at least about 10% by weight of the nanoparticles; at least about 25% by weight of the nanoparticles; or at least about 50% by weight of the nanoparticles. The composition can be a solid, such as a film. The composition can also be a solution or suspension, such as the nanoparticles dissolved or dispersed in a solvent.

In some embodiments, the composition includes one or more polymers that are disclosed in the present application. The composition can, for example, include at least about 0.1% by weight of the one or more polymers; at least about 0.5% by weight of the one or more polymers; at least about 1% by weight of the one or more polymers; at least about 5% by weight of the one or more polymers; at least about 10% by weight of the one or more polymers; at least about 25% by weight of the one or more polymers; or at least about 50% by weight of the one or more polymers. In some embodiments, the composition includes an amount of the one or more polymers that is effective to remove at least about 50% by weight of the heavy metal ions in the composition. In some embodiments, the composition includes an amount of the one or more polymers that is effective to remove at least about 75% by weight of the heavy metal ions in the composition. In some embodiments, the composition includes an amount of the one or more polymers that is effective to remove at least about 80% by weight of the heavy metal ions in the composition. In some embodiments, the composition includes an amount of the one or more polymers that is effective to remove at least about 90% by weight of the heavy metal ions in the composition.

The nanoparticles can have various sizes. For example, the nanoparticles can have a size of about 0.1 nm to about 1000 nm, a size of about 1 nm to about 500 nm a size of about 5 nm to about 400 nm, a size of about 4 nm to about 300 nm, a size of about 3 nm to about 200 nm, a size of about 2 nm to about 100 nm, a size of about 10 nm to about 70 nm, or a size of about 20 nm to about 50 nm. In some embodiments, the nanoparticles have a size of about 20 nm to about 200 nm. In some embodiments, the nanoparticles have a size of about 30 nm to about 160 nm. In some embodiments, the nanoparticles have a size of about nm to about 140 nm. In some embodiments, the nanoparticles have a size of about 50 nm to about 120 nm. In some embodiments, the nanoparticles have a size of about 80 nm to about 100 nm.

The nanoparticles can have various apparent densities. For example, the nanoparticles can have an apparent density of about 0.02 g/cm³ to about 10 g/cm³, about 0.05 g/cm³ to about 5 g/cm³, about 0.1 g/cm³ to about 2 g/cm³, about 0.15 g/cm³ to about 1.5 g/cm³, or about 0.2 g/cm³ to about 1 g/cm³. In some embodiments, the nanoparticles have an apparent density of about 0.2 g/cm³ to about 1 g/cm³. In some embodiments, the nanoparticles have an apparent density of about 0.5 g/cm³. In some embodiments, the nanoparticles have an apparent density of about 0.45 g/cm³.

The nanoparticles can have various bulk densities. For example, the nanoparticles can have a bulk density of about 0.01 g/cm³ to about 10 g/cm³, about 0.05 g/cm³ to about 5 g/cm³, about 0.1 g/cm³ to about 3 g/cm³, about 0.2 g/cm³ to about 2 g/cm³, or about 0.1 g/cm³ to about 1 g/cm³. In some embodiments, the nanoparticles have a bulk density of about 0.3 g/cm³ to about 1 g/cm³. In some embodiments, the nanoparticles have a bulk density of about 0.6 g/cm³.

The nanoparticles can have various average BET specific areas. For example, the nanoparticles can have an average BET specific area of about 1 m²/g to about 10000 m²/g, about 5 m²/g to about 8000 m²/g, about 10 m²/g to about 5000 m²/g, about 20 m²/g to about 2000 m²/g, about 50 m²/g to about 1000 m²/g, or about 100 m²/g to about 500 m²/g. In some embodiments, the nanoparticles have an average BET specific area of about 15 m²/g to about 1000 m²/g. In some embodiments, the nanoparticles have an average BET specific area of about 115 m²/g.

The nanoparticles can have various average pore diameters. For example, the nanoparticles can have an average pore diameter of about 1 nm to about 1000 nm, about 2 nm to about 500 nm, about 5 nm to about 200 nm, about 8 nm to about 150 nm, about 10 nm to about 100 nm, or about 15 nm to about 50 nm. In some embodiments, the nanoparticles have an average pore diameter of about 10 nm to about 50 nm. In some embodiments, the nanoparticles have an average pore diameter of about 20 nm.

### Method of Making Polymers

Some embodiments disclosed herein include a method of making a polymer, the method comprising: forming a composition comprising at least one oxidizing agent and at least one monomer represented by a structure selected from Formula IV, Formula V and Formula VI:

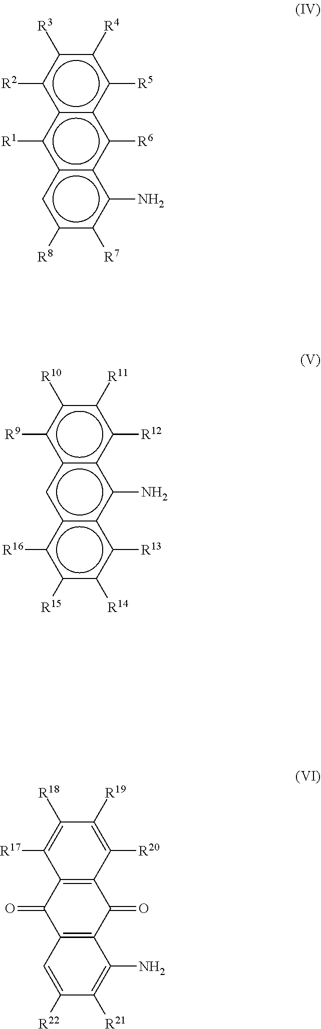

Where R¹, R², R³, R⁴, R⁵, R⁶, R⁷, R⁸, R⁹, R⁰, R¹¹, R¹², R¹³, R¹⁴, R¹⁵, R¹⁶, R¹⁷, R¹⁸, R¹⁹, R²⁰, R²¹, and R²² are the same as described above with respect to Formulae I, II, and III; and maintaining the composition under conditions effective to polymerize the monomer to form the polymer. Any of the polymers described in the present application can be prepared using this process.

The skilled artisan, guided by the teachings of the present application, will appreciate that any of the monomer units described above with respect to the polymer structure can have corresponding monomers that will form the monomer units upon polymerization. Thus, for example, R¹, R², R³, R⁴, R⁵, R⁶, R⁷, R⁸ can be selected in the monomer represented by Formula IV to form a monomer unit in the polymer that is represented by Formula I and includes the same substitutions. It is therefore contemplated that certain embodiments of the method include polymerizing one or more specific monomer structures that correspond with one or more of the monomer units described above. Similarly, amounts of the monomer components, as well as the total amount of each monomer component in the polymer, may also be the same as discussed above with respect to the polymer. For example, the polymer can be a homopolymer prepared from a single monomer that corresponds to one of the monomer units represented by Formula I, II, or III.

Non-limiting examples of monomer represented by Formula IV include: 5-sulfo-1-aminoanthraquinone (SA), 1-aminoanthraquinone-5-sulphonic acid sodium salt, 1-aminoanthraquinone-2-sulphonic acid, and 1,5-diaminoanthraquinone-2-sulphonic acid.

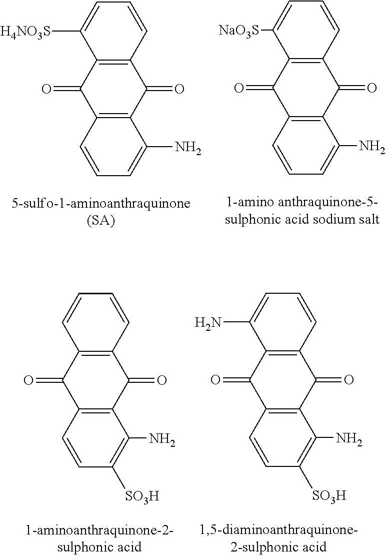

Non-limiting examples of monomer represented by Formula V include 9-aminoanthracene.

Non-limiting examples of monomer represented by Formula VI include: 5-sulfo-1-aminoanthraquinone (SA), 1-aminoanthraquinone-5-sulphonic acid sodium salt, 1-aminoanthraquinone-2-sulphonic acid, and 1,5-diaminoanthraquinone-2-sulphonic acid.

The steps and/or conditions for forming the polymer are not particularly limited and may be varied depending upon the desired properties of the polymer. For example, various solvents may be included in the composition having the monomers and oxidizing agent. The polymerization solvent can be, for example, water or an organic solvent, such dimethylformamide (DMF), or mixtures thereof (e.g., 1:1 by vol. of DMF-H₂O). In some embodiments, the monomer and oxidizing agent may be in an acid solution. The pH of the solution can be, for example, less than or equal to about 6; less than or equal to about 5; less than or equal to about 4; or less than or equal to about 3. As one example, the polymerization solvent can include a protonic acid, such as 50 mM of H₂SO₄ or 100 mM of H₂SO₄. Of course, various other pH modifying agents could be used to adjust and/or maintain the pH of the composition to a desired pH.

Thus, oxidative agent is not particularly limited. The oxidizing agent can be, for example, K₂CrO₄, K₂Cr₂O₇, CrO₃, HClO, KMnO₄, or combinations thereof. In some embodiments, the oxidizing agent is K₂CrO₄. In some embodiments, the oxidizing agent is K₂Cr₂O₇. In some embodiments, the oxidizing agent is CrO₃.

The molar ratio of the oxidizing agent to the monomer components in the composition can be modified, for example, to adjust the properties of the polymer. The relative molar ratio of the oxidizing agent to the monomer in the composition can be, for example, at least about 0.5:1, at least about 1:1, at least about 1.5:1, at least about 2:1, at least about 2.5:1, at least about 3:1, at least about 3.5:1, or at least about 4:1. The relative molar ratio of the monomer to the oxidizing agent in the composition can be, for example, less than or equal to about 5:1, less than equal to about 4.5:1, less than or equal to about 4:1, less than equal to about 3.5:1, or less than equal to about 3:1. In some embodiments, the relative molar ratio of the oxidizing agent to the monomer is about 2:1.

After forming the composition having the monomer and oxidizing agent, the composition can be maintained at conditions effective to polymerize the monomer to form the copolymer. For example, the composition can be maintained at about atmospheric pressure and a temperature of about 0° C. to about 100° C., about 5° C. to about 80° C., about 10° C. to about 60° C., about 15° C. to about 50° C., about 20° C. to about 40° C., or about 25° C. to about 35° C. In some embodiments, the temperature can be about 15° C. to about 25° C. Non-limiting examples of polymerization temperature include about 15° C., about 20° C., about 25° C., about 30° C., about 35° C., about 40° C., about 45° C., about 50° C., and ranges between any two of these values.

The composition can be maintained at the conditions for a period of time sufficient to obtain the polymer. The composition, for example, can be maintained at the conditions for at least about 1 hour, at least about 12 hours, at least about 24 hours, at least about 36 hours, at least about 48 hours, at least about 60 hours, at least about 72 hours, at least about 84 hours, at least about 96 hours, at least about 108 hours, at least about 120 hours, at least about 144 hours, and ranges between any two of these values. In some embodiments, the polymerization time is from about 24 hours to 72 hours. In some embodiments, the polymerization time is about 72 hours.

Methods for Removing Metal Ions from a Sample

Some embodiments of the present application include methods for removing metal ions from a sample. Without being bound to any particular theory, it is believed that the ═O, —NH—, —N═, —NH₂, or —SO₃H group present in the polymer disclosed in the present application can efficiently bind metal ions through sharing lone pair electrons to form metal chelates with stable multiple six-member ring structures. The multi chelating sites in the polymer can facilitate the chelation with the metal ions.

In some embodiments, a method for removing metal ions from a sample includes: (a) providing an untreated sample suspected of containing one or more metal ions; and (b) contacting the sample and a composition to form a treated sample, wherein the composition comprises a polymer comprising a monomer unit represented by the structure selected from Formula I, Formula II and Formula III.

Non-limiting examples of metal ions that can be removed using the methods disclosed in the present application include heavy metal ions, noble metal ions, nutritious metal ions, and ions of rare earth metal. Examples of heavy metal ion include As(III), As(V), Cd(II), Cr(VI), Pb(II), Hg(II), Sb(III), Sb(V), Ni(II), Ag(I) and Tl(III). Examples of nutritious metal ion include K(I), Na(I), Ca(II), Mg(II), Fe(II), Fe(III), Zn(II), Cu(II), and Co(II). Examples of noble metal ions are Ag(I), Au(I), Au(III), Pt(II), Pt(IV), Ir(III), Ir(IV), Ir(VI), Pd(II), and Pd(IV). Examples of ions of rare earth metal are La(III), Pr(III), Nd(III), Sm(III), Gd(III), Dy(III), Y(III), and Er(III). In some embodiments, the metal ion is Pb(II). In some embodiments, the metal ion is Hg(II). In some embodiments, the metal ion is Cu(II) or Au(I). In some embodiments, the metal ion is Fe(III) or Zn(II). In some embodiments, the metal ion is Au(I).

Various types of samples can be treated by the polymers as described in the present application for removing metal ions. In some embodiments, the sample is an aqueous sample. In some embodiments, the untreated sample is wastewater. In some embodiments, the untreated sample is sewage, plant discharge, groundwater, polluted river water, industrial waste, battery waste, electroplating wastewater, liquid waste in chemical analysis, or laboratory waste. In some embodiments, the untreated sample is automotive exhaust. The concentration of the metal ion in the untreated sample can be from about 0.0001 mg/L to about 10 g/L, from about 0.0005 mg/L to about 8 g/L, from about 0.001 mg/L to about 5 g/L, from about 0.005 mg/L to about 4 g/L, from about 0.01 mg/L to about 3 g/L, from about 0.01 mg/L to about 2 g/L, from 0.01 mg/L to about 1 g/L, from about 0.05 mg/L to about 0.5 g/L, or from about 0.1 mg/L to about 0.1 g/L. In some embodiments, the concentration of the metal ion in the untreated sample is no more than about 5 g/L. In some embodiments, the concentration of the metal ion is from about 0.01 mg/L to about 1 g/L. In some embodiments, the concentration of the metal ion in the untreated sample is about 200 mg/L. In some embodiments, the concentration of the metal ion in the untreated sample is about 20 mg/L.

The polymers described in the present application can be potent adsorbents for metal ions. For example, the removal percentage of the metal ion in a sample can be at least about 20% by weight, at least about 30% by weight, at least about 40% by weight, at least about 50% by weight, at least about 60% by weight, at least about 70% by weight, at least about 80% by weight, at least about 90% by weight, at least about 95% by weight, or at least about 99% by weight. In some embodiments, the removal percentage of the metal ion is at least about 85%. In some embodiments, the removal percentage of the metal ion is at least about 90% by weight. In some embodiments, the removal percentage of the metal ion is at least about 95% by weight. In some embodiments, the removal percentage of the metal ion is at least about 99% by weight. In some embodiments, the removal percentage of the metal ion is at least about 99.5% by weight.

Various amount of the polymer can be used to remove a metal ion from a sample. The polymer can be added to the composition at a concentration of, for example, at least about 1 mg/L; at least about 10 mg/L; at least about 50 mg/L; at least about 100 mg/L; at least about 500 mg/L; at least about 1 g/L; at least about 10 g/L; at least about 50 g/L; at least about 100 g/L; at least about 500 g/L; or at least about 1000 g/L. The polymer can be added to the composition at a concentration of, for example, less than or equal to about 5000 g/L; less than or equal to about 4000 g/L; less than or equal to about 2000 g/L; less than or equal to about 1000 g/L; less than or equal to about 800 g/L; less than or equal to about 500 g/L; less than or equal to about 250 g/L; less than or equal to about 100 g/L; less than or equal to about 50 g/L; or less than or equal to about 10 g/L.

In some embodiments, the untreated sample has a higher concentration of the metal ion than the treated sample. For example, the concentration of the metal ion in the untreated sample can be, for example, at least about 5 times higher, at least about 10 times higher, at least about 15 times higher, at least about 20 times higher, at least about 25 times higher, at least about 30 times higher, at least about 35 times higher, at least about 40 times higher, at least about 45 times higher, at least about 50 times higher, at least about 60 times higher, or at least about 100 times higher, than the concentration of the metal ion in the treated sample. The concentration of the metal ion in the treated sample can be less than, for example, about 20% by weight, about 15% by weight, about 10% by weight, about 5% by weight, about 4% by weight, about 3% by weight, about 2% by weight, about 1% by weight, about 0.5% by weight, about 0.2% by weight, about 0.1% by weight, about 0.05% by weight, or about 0.01% by weight of the concentration of the metal ion in the untreated sample.

In some embodiments, the sample is in contact with the composition containing the polymer for from about 0.01 hour to about 100 hours, from about 0.1 hour to about 50 hours, from about 1 hour to about 40 hours, from about 5 hours to about 24 hours, from about 10 hour to about 12 hours. In some embodiments, the sample is in contact with the composition for about 24 hours. In some embodiments, the sample is in contact with the composition for about 1 hour. In some embodiments, the adsorption time at equilibrium is about 1 hour. In some embodiments, the adsorption time at equilibrium is about 30 minutes. In some embodiments, the adsorption time at equilibrium is at most about 30 minutes, at most about 1 hour, at most about 5 hours, or at most about 10 hours.

The temperature of the sample while contacting the composition containing the polymer can be varied. The temperature can be, for example, in the range of about 0° C. to about 60° C. In some embodiments, the sample may be heated above room temperature. In some embodiments, the sample may be maintained at a selected temperature while the composition containing the polymer contacts the sample.

The method may also optionally include isolating the polymer from the sample. Various methods of isolating the polymer can be used, such as filtering or centrifuging. As one example, after the polymer has contacted the sample for sufficient time to adsorb metal ions, the sample can be filtered to remove the polymer. The filter may, for example, be configured to remove nanoparticles containing the polymer.

In some embodiments, the metal ion that has been adsorbed by the PSA polymers can be removed from the polymer. The polymer may, in some embodiments, be used repeatedly for removing metal ions from samples. As one example, the polymer can be combined with a protonic acid, such nitric acid to release the metal ions from the polymer. The polymer can then be isolated and reused.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### EXAMPLES

Additional embodiments are disclosed in further detail in the following examples, which are not in any way intended to limit the scope of the claims.

### Example 1

### Polymerization of Poly(5-sulfo-1-aminoanthraquinone) (PSA)

The chemical oxidative polymerization of 5-sulfo-1-aminoanthraquinone (SA) monomer for the synthesis of the PSA particles was carried out with CrO₃, K₂Cr₂O₇ or K₂CrO₄ as oxidant in water with 50 mM HClO₄ at 25° C. for 72 hours.

A typical procedure included adding SA monomer (1.0 g, 3.12 mmol) to 220 mL distilled water in a 500 mL glass flask in a water bath at 25° C. with vigorous stirring for 10 minutes. An oxidant solution was prepared separately by dissolving the oxidant CrO₃, K₂Cr₂O₇, or K₂CrO₄ (6.24 mmol) and 1.07 mL 70% HClO₄ in 30 mL distilled water at 25° C. The SA monomer solution was treated with the oxidant solution in one portion. The reaction mixture was magnetically and continuously stirred for 72 hours at 25° C., accompanying by measurement of the open circuit potential (OCP) and temperature of the polymerization solution. Then, the PSA polymer particles as precipitates were isolated from the reaction mixture by centrifugation and washed with an excess of distilled water to remove unpolymerized monomer, residual oxidant, water-soluble oligomers, and water-soluble reduced by-products. The polymers were redoped in 1.0 M HClO₄ aqueous solution (20 mL) with stirring for a whole day and left to dry at 50° C. in ambient air for 3 days. The PSA polymers were obtained as very fine solid black powders. The nominal oxidative polymerization using K₂CrO₄ as the oxidant is shown in Scheme 1.

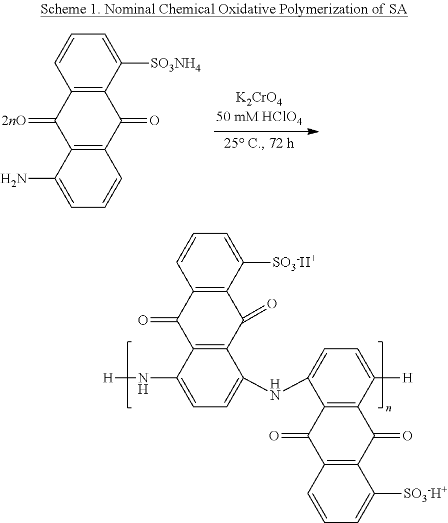

### Example 2

### Properties of PSA Polymer Particles

PSA polymers were prepared according to Example 1. The morphology of those PSA polymers (dispersed in water) were evaluated by laser particle analyzer (LPA), field emission-scanning electron microscopy (FESEM) and atomic force microscopy (AFM). The size, size distribution and morphology of the PSA polymers were analyzed on a Beckman Coulter LS230 laser particle-size analyzer, a Quanta 200 FEG field-emission scanning electron microscope and a SPA-300HV atomic force microscope. The apparent and bulk density of the PSA polymers was determined by the ratio of the mass to a given volume of 2 cm³, where the fine PSA particles were put into a plastic tube with a scale and stacked loosely and tightly. The bulk electrical conductivity of the PSA polymers was measured by a two-disk method at 15-20° C. Simultaneous thermogravimetric (TG) and differential scanning calorimetry (DSC) measurements were performed in static air with a sample size of 3 mg at a temperature range from room temperature to 787° C. at a heating rate of 10° C./min by using an STA 449C Jupiter thermal analyzer.

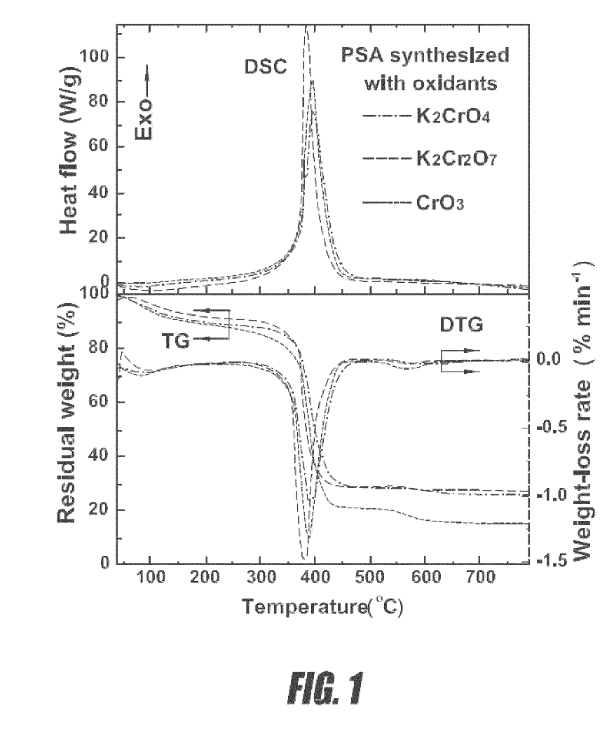

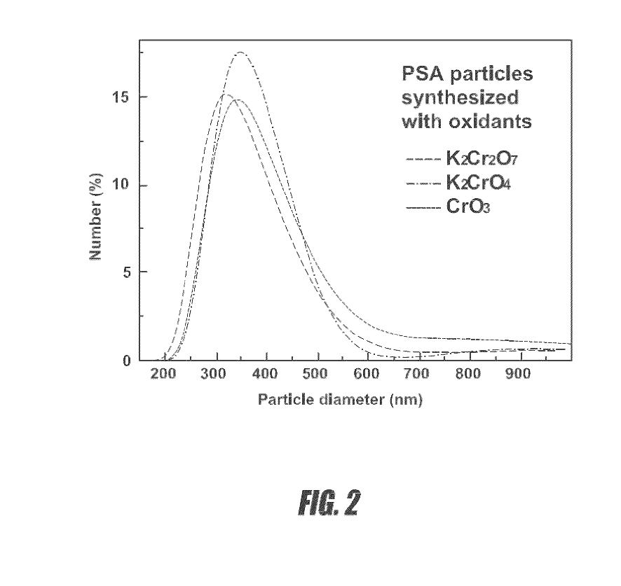

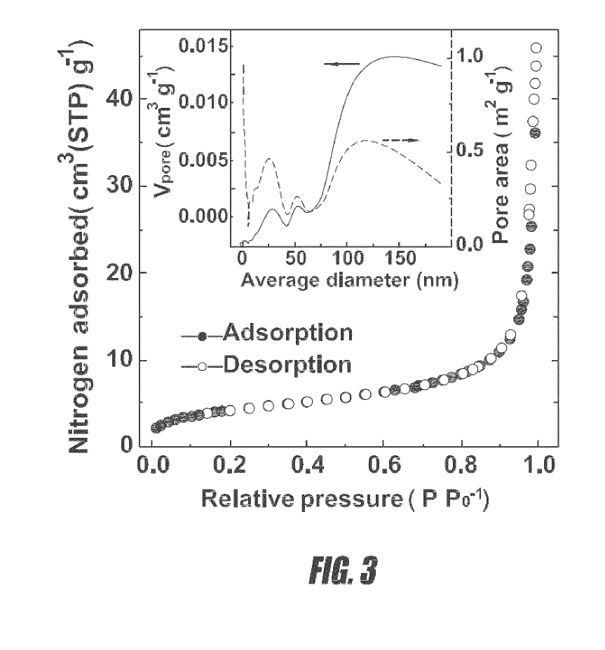

The synthetic yield and various properties of the PSA polymer particles prepared according to Example 1 are shown in Table 1. DSC, TG and differential thermogravimetric (DTG) curves of those PSA polymers are shown in FIG. 1. Size distribution curves of the PSA polymer particles (dispersed in water) are shown in FIG. 2. Nitrogen adsorption-desorption isotherms and pore size distribution curves of the PSA polymer particles are shown in FIG. 3.

TABLE 1
Summary of Properties of PSA Polymers

| | | Oxidants | | |
|---|---|---|---|---|
| | | K₂CrO₄ | K₂Cr₂O₇ | CrO₃ |
| HClO₄ concentration (mM) | | 50 | 50 | 50 |
| Polymerization temperature (° C.)/time (h) | | 25/72 | 25/72 | 25/72 |
| Synthetic yield (%) | | 43.4 | 34.9 | 49.8 |
| Dₙ (nm)/PDI by LPA | | 382/1.12 | 368/1.08 | 353/1.14 |
| Particle size by SEM | | 65-190 | 65-160 | 50-160 |
| Particle size (nm) by AFM | | 20-43 | 24-43 | 20-43 |
| Bulk electrical | Virgin HClO₄ doped salt | 1.45 × 10⁻⁸ | 8.43 × 10⁻⁸ | 6.22 × 10⁻⁹ |
| conductivity (S cm⁻¹) | 1M HClO₄ redoped salt | 5.90 × 10⁻⁶ | 3.60 × 10⁻⁵ | 5.9 × 10⁻⁶ |

| | | | |
|---|---|---|---|
| Temperature at maximal endothermicity (° C.) | 71.9 | 104.4 | 82.3 |
| Maximal endothermicity (W/g⁻¹) | 1.33 | 3.21 | 0.01 |
| Decomposition temperature at 15% weight loss | 341.9 | 349.4 | 299.8 |
| (° C.) | | | |
| Temperature at the maximal exothermicity (° C.) | 396.9 | 386.9 | 397.3 |
| Maximal exothermicity (W g⁻¹) | 76.2 | 114.0 | 90.9 |
| Temperature at 1^{st}/2^{nd} maximal weight-loss rates | 81.9/391.9 | 104.4/381.9 | 82.3/392.3 |
| (° C.) | | | |
| 1^{st}/2^{nd} maximal weight-loss rates (% min⁻¹) | 0.09/1.06 | 0.08/1.49 | 0.11/1.34 |
| Char yield at 787° C. (wt %) | 25.6 | 27.1 | 15.0 |

This example demonstrates that the PSA polymers are an electrical semiconductor like other aromatic amine polymers obtained by oxidative polymerization, and are highly thermostable. Also the PSA polymers synthesized using K₂CrO₄ as the oxidant have high synthetic yield and high electrical conductivity.

### Example 3

### Element Analysis

PSA polymers were prepared according to Example 1 and examined for their macromolecular structure. The PSA polymers were conjectured from C/H/N/S/O/Cr ratio determined by element analysis carried out on a VARIO EL III element analyzer. The chromium content was determined by an ICP-AES method by digesting the PSA particles in 65% HNO₃-30% H₂O₂ (3:2 V/V) at about 50° C. until a clear colorless final mixed solution was obtained. The results of the element analysis and proposed chain structures are shown in

TABLE 2
Elemental Analysis and Proposed Chain Structures of Virgin PSA

| PSA | Virgin doped PSA salt |
|---|---|
| C/H/N/S/O/Cr | 41.12/3.295/3.565/6.594/36.31/6.95 |
| (wt %) | |
| Experimental | C₁₄H_{13.46}N_{1.04}S_{0.84}O_{9.27}Cr_{0.55} |
| formula | |
| Calculated | C₁₄H₇NSO₅(CrO₂)_{0.55}(H₂O)₃ |
| formula | |
| Proposed chain structure | 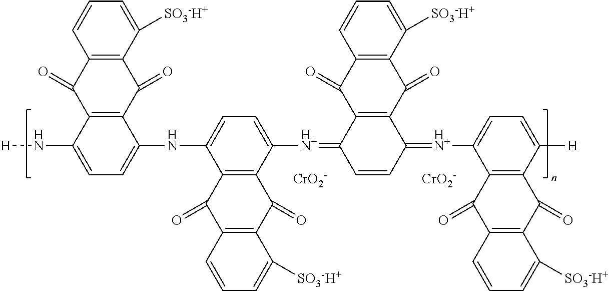 |
| PSA | Lightly doped PSA salt |
| C/H/N/S/O/Cr | 52.45/2.10/4.41/9.61/27.46/3.97 |
| (wt %) | |
| Experimental | C₁₄H_{6.73}N_{1.01}S_{0.96}O_{5.5}Cr_{0.24} |
| formula | |
| Calculated | C₁₄H_{6.5}NSO₅(HCrO₂)_{0.25} |
| formula | |
| Proposed chain structure | 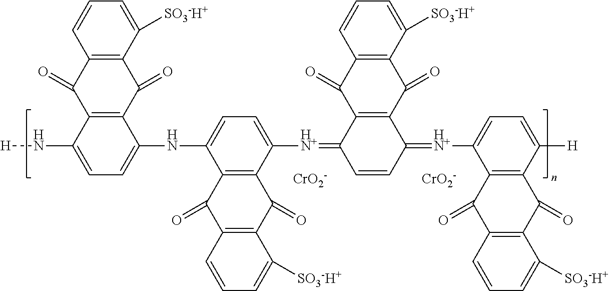 |

### Example 4

### Modifying Polymerization Conditions

Additional PSA polymers were prepared using generally the same procedures described in Example 1. However, in one set of experiments, the oxidant was CrO₃ and neutral water was used as solvent. The synthetic yield and various properties of these PSA polymers were determined similarly with the procedures described in Example 1. The results are shown in Table 3.

TABLE 3
Summary of Properties of PSA Polymers

| | | Oxidants |
|---|---|---|
| | | CrO₃ |
| HClO₄ concentration (mM) | | 0 |
| Polymerization temperature (° C.)/time (h) | | 15/48 |
| Synthetic yield (%) | | 5 |
| Bulk electrical Conductivity | Virgin HClO₄ doped salt | 2.38 × 10⁻⁹ |
| (S cm⁻¹) | 1M HClO₄ redoped salt | 3.25 × 10⁻⁶ |

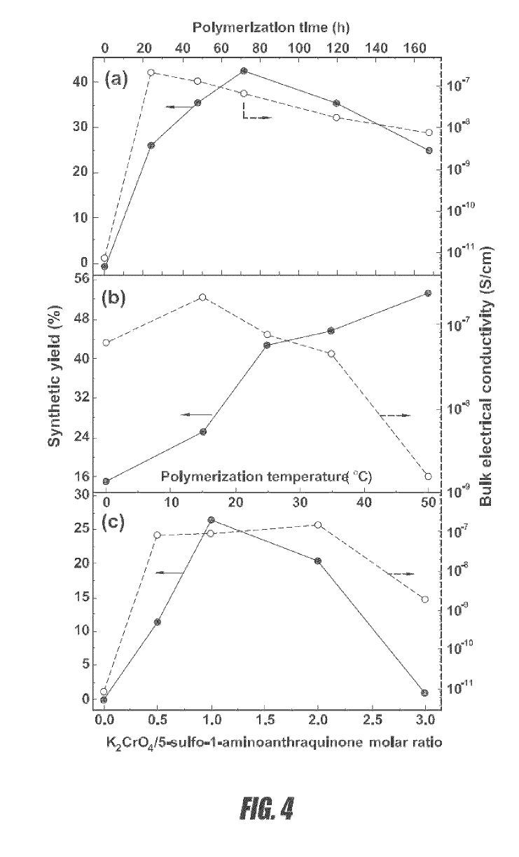

In another set of experiments, the polymerization time varied from 0 hour to 72 hours to synthesize PSA polymer particles. The changes in synthetic yield and bulk electrical conductibility with a change in polymerization time are shown in FIG. 4a.

In yet another set of experiments, the polymerization temperature varied from 0° C. to 50° C. to synthesize PSA polymer particles. The changes in synthetic yield and bulk electrical conductibility with a change in polymerization temperature are shown in FIG. 4b.

In still another set of experiments, the molar ratio of K₂CrO₄ oxidant to SA monomer varied from 0:1 to 3:1 to synthesize PSA polymer particles. The changes in synthetic yield and bulk electrical conductibility with a change in molar ratio of oxidant/monomer are shown in FIG. 4c.

In one set of experiments, 50 mM H₂SO₄, HCl or HNO₃ was used as the solvent to synthesize PSA polymer particles. The synthetic yield and bulk electrical conductivity of these PSA polymers are summarized in Table 4.

TABLE 4
Summary of Synthetic Yields and Bulk Electrical Conductivities

| Acid species | | | |
|---|---|---|---|
| H₂SO₄ | HCl | HClO₄ | HNO₃ |
| Oxidant | | | |
| K₂CrO₄ | K₂CrO₄ | K₂CrO₄ | K₂CrO₄ |

A. Polymerization at 15° C. for 48 h

| | | | | |
|---|---|---|---|---|
| Synthetic yield | 2.13 | 27.6 | 20.7 | 21.6 |
| (%) | | | | |
| Electrical | 3.39 × 10⁻⁹ | 9.30 × 10⁻⁸ | 1.64 × 10⁻⁷ | 2.50 × 10⁻⁷ |
| conductivity | | | | |
| (S cm⁻¹) | | | | |

B. Polymerization at 50° C. for 24 h

| | | | | |
|---|---|---|---|---|
| Synthetic yield | — | 40.9 | 34.7 | 30.0 |
| (%) | | | | |
| Electrical | — | 1.70 × 10⁻⁸ | 2.40 × 10⁻⁸ | 3.40 × 10⁻⁸ |
| conductivity | | | | |
| (S cm⁻¹) | | | | |

In another set of experiments, the solvent was 0 mM, 10 mM, 50 mM, or 100 mM HNO₃ to synthesize PSA polymer particles. The synthetic yield and bulk electrical conductivity of these PSA polymers are summarized in Table 5.

TABLE 5
Summary of Synthetic Yields and Electrical Conductivities

| | | | | |
|---|---|---|---|---|
| HNO₃ concentration (mM) | 0 | 10 | 50 | 100 |
| Synthetic yield (%) | 0 | 15.5 | 21.6 | 0 |
| Electrical conductivity (S cm⁻¹) | — | 6.20 × 10⁻⁸ | 2.50 × 10⁻⁷ | — |

This example demonstrates that various factors in the polymerization condition, such as polymerization time, polymerization temperature, relative molar ratio of oxidant/monomer, acid species for the solvent, acid concentration of the solvent, contribute to the synthetic yield and properties of the PSA polymers.

### Example 5

### Chemoresistance of PSA Polymers

PSA polymer powders were prepared according to Example 1. Chemoresistance of those PSA polymers and SA monomers was evaluated by adding polymer powders of 2 mg into the solvent of 1 mL and shaking the mixture intermittently for 2.0 hours at ambient temperature. The results are shown in Table 6.

TABLE 6
Solubility and Solution Color of SA Monomer and PSA Polymers

| | Solubility and Solution Color | | | |
|---|---|---|---|---|
| | PSA Polymer prepared by three oxidants | | | |
| Solvent | CrO₃ | K₂Cr₂O₇ | K₂CrO₄ | SA monomer |
| Water | insoluble | insoluble | Insoluble | soluble, wine |
| CH₃COOH | insoluble | insoluble | Insoluble | soluble, orange |
| Acetone | insoluble | insoluble | Insoluble | partially soluble, |
| | | | | yellow |
| Tetrahydrofuran | insoluble | insoluble | Insoluble | slightly soluble |
| N,N- | slightly soluble | slightly soluble | slightly | soluble, |
| Dimethylformamide | | | soluble | dark brown |
| N- | slightly soluble | slightly soluble | slightly | soluble, orange |
| Methylpyrrolidone | | | soluble | |
| Dimethylsulfoxide | partially | partially | partially | soluble, orange |
| | soluble, cyan | soluble, cyan | soluble, cyan | |
| Propylene carbonate | partially | partially | partially | mainly soluble, |
| | soluble, cyan | soluble, cyan | soluble, cyan | yellow |
| 1.0M HClO₄ | partially | partially | partially | mainly soluble, |
| | soluble, | soluble, | soluble, | wine |
| | dark cyan | dark cyan | dark cyan | |
| 17.8M H₂SO₄ | soluble, | soluble, | soluble, | soluble |
| | dark green | dark green | dark green | |
| 11.6M HClO₄ | soluble, yellow | soluble, yellow | soluble, | soluble |
| | | | yellow | |
| 10 mM NaOH | soluble, cyan | soluble, cyan | soluble, cyan | soluble, orange |
| 200 mM NH₄OH | soluble, | soluble, | soluble, | soluble |
| | dark cyan | dark cyan | dark cyan | |

This example demonstrates that the PSA polymers have significantly different chemoresistance as compared to the SA monomers.

### Example 6

### UV-Vis Spectra of the PSA Polymers

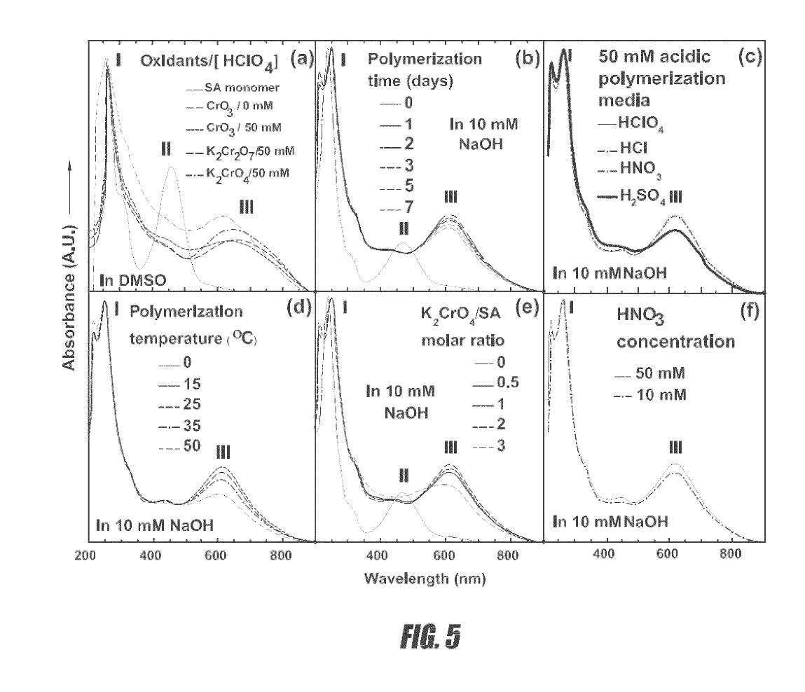

PSA polymers were prepared according to Examples 1 and 4. UV-vis spectra of those PSA polymers at a concentration of 10 mg/L in DMSO or 10 mM NaOH aqueous medium were measured on a 760CRT UV-vis spectrophotometer at a wavelength range of 900-200 nm at a scanning rate of 480 nm/minute. The results are shown in FIG. 5. PSA polymers shown in FIG. 5a were synthesized with the oxidant/SA molar ratio of 2 at 25° C. for 72 hours; PSA polymers shown in FIG. 5b were prepared with K₂CrO₄ at the oxidant/SA molar ratio of 2 at 25° C. for different polymerization times; PSA polymers shown in FIG. 5c were prepared with K₂CrO₄ oxidant/SA molar ratio of 2 in 50 mM four acid aqueous solutions at a constant 15° C. for 48 h; PSA polymers shown in FIG. 5d were prepared with K₂CrO₄ at the oxidant/SA molar ratio of 2 at different polymerization temperatures for 72 hours; PSA polymers shown in FIG. 5e were prepared with K₂CrO₄ at different oxidant/SA molar ratios at 15° C. for 48 hours in a 50 mM HClO₄; PSA polymers shown in FIG. 5f were prepared with K₂CrO4 oxidant/SA molar ratio of 2 in 10 and 50 mM HNO₃ aqueous solutions at a constant 15° C. for 48 hours. The solvent used for UV-vis spectral tests was DMSO in FIG. 5a and was 10 mM NaOH in FIGS. 5b-f.

The large difference between the UV-vis spectra of the SA monomer and that of the PSA polymers demonstrates that the PSA polymers are genuine polymers rather than simple chelates or mixture of monomers with some oligomers.

### Example 7

### Adsorption of Lead and Mercury Ions

PSA polymer powders were prepared according to Example 1. Those PSA polymers were evaluated for their adsorbability of lead and mercury ions. A 25 mL aqueous solution containing 200 mg L⁻¹ of Pb(NO₃)₂ or Hg(NO₃)₂ was incubated with 50 mg or 100 mg PSA polymers at 30° C. for 24 hours or 1 hour without ultrasonic treatment. After incubation, the PSA polymers were filtered from the solution. The ion concentration in the filtrate was measured by molar titration at higher ion concentration and by inductively coupled plasma (ICP) analysis at lower ion concentration on a Thermo E. IRIS Duo ICP emission spectrometer. The concentration of lead and mercury ions of the solutions before after incubating with PSA polymers was simultaneously determined by the ICP analysis. The adsorption results are shown in Table 7.

TABLE 7
Pb(II) and Hg(II) Adsorption

| | | | | | Metal-ion | | Conductivity |
|---|---|---|---|---|---|---|---|
| | | Amount | [Initial | | | Adsorptivity | after ion |
| | Adsorption | of PSA | metal-ion] | [Final metal- | Adsorbance | (percentage | adsorption |
| Oxidant | Time | Polymer | (mg L⁻¹) | ion] (mg L⁻¹) | (mg g⁻¹) | reduction) | (S cm⁻¹) |
| | | | Pb(II) ions | | | | |
| CrO₃ | 24 hours | 50 mg | 200 | 32.2 | 83.9 | 83.9 | 3.41 × 10⁻⁸ |
| K₂Cr₂O₇ | 24 hours | 50 mg | 200 | 29.6 | 85.2 | 85.2 | 6.92 × 10⁻⁸ |
| K₂CrO₄ | 24 hours | 50 mg | 200 | 20.8 | 89.6 | 89.6 | 4.18 × 10⁻⁷ |
| | 1 hour | 100 mg | 200 | 0.8 | 49.8 | 99.6 | N/A |
| | | | Hg(II) ions | | | | |
| CrO₃ | 24 hours | 50 mg | 200 | 22.8 | 88.6 | 88.6 | 4.10 × 10⁻⁸ |
| K₂Cr₂O₇ | 24 hours | 50 mg | 200 | 18.6 | 90.7 | 90.7 | 8.99 × 10⁻⁸ |
| K₂CrO₄ | 24 hours | 50 mg | 200 | 15.0 | 92.5 | 92.5 | 5.85 × 10⁻⁷ |
| | 1 hour | 100 mg | 200 | 0.4 | 49.9 | 99.8 | N/A |

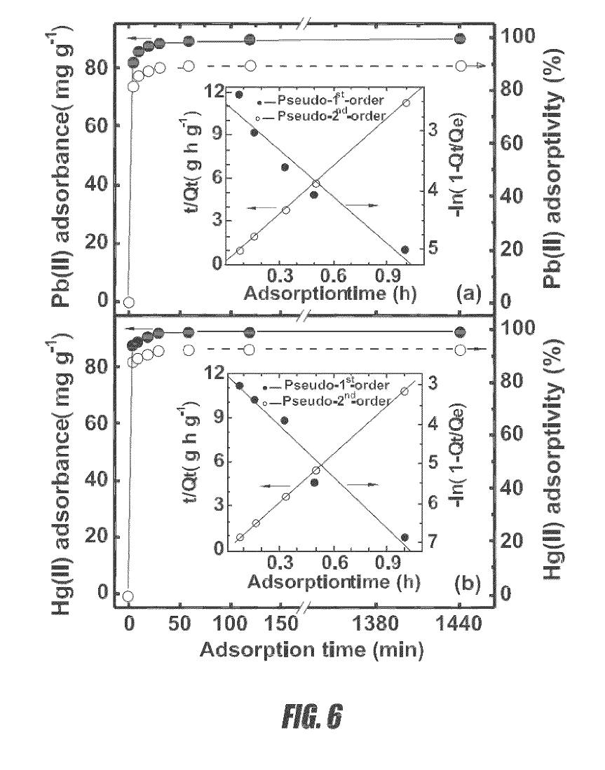

Representative plots of Pb(II) and Hg(II) absorbance and adsorptivity versus adsorption time onto the PSA polymers obtained using K₂CrO₄ as the oxidant are shown in FIG. 6. Corresponding kinetics model equations are shown in Table 8.

TABLE 8
Kinetics Model Equations for Pb(II) and Hg(II) Adsorption

| | | | | k₁ (h⁻¹) | | |
|---|---|---|---|---|---|---|
| | | Linear | | k₂ (g mg⁻¹ h⁻¹) | | |
| Mathematical | | correlation | Standard | h₀ = k₂Qe² | Qₑ found by | |
| model | Equation | coefficient R | deviation | (mg g⁻¹h⁻¹) | experiment | equation |

Pb(II) adsorption

| | | | | | | |
|---|---|---|---|---|---|---|
| Pseudo-1^{st}- | −ln(1 − Qₜ/Qₑ) = | 0.96753 | 0.29042 | k₁ = 2.65033 | 89.6 | — |
| order | 2.65033t + 2.52682 | | | | | |
| Pseudo-2^{nd}- | t/Qₜ = | 1 | 8.49 × 10⁻⁶ | k₂ = 1.28921 | 89.6 | 89.7 |
| order | 0.01115t + 9.66176 × 10⁻⁵ | | | h₀ = 1.035 × 10⁴ | | |

Hg(II) adsorption

| | | | | | | |
|---|---|---|---|---|---|---|
| Pseudo-1^{st}- | −ln(1 − Qₜ/Qₑ) = | 0.97782 | 0.38687 | k₁ = 4.30587 | 92.5 | — |
| order | 4.30587t + 2.71089 | | | | | |
| Pseudo-2^{nd}- | t/Qₜ = | 0.99999 | 2.05 × 10⁻⁵ | k₂ = 1.65259 | 92.5 | 92.7 |
| order | 0.01079t + 7.07291 × 10⁻⁵ | | | h₀ = 1.414 × 10⁴ | | |

This example demonstrates that the PSA polymers can be efficient and effective adsorbents for lead and mercury ions.

### Example 8

### IR Spectra of the PSA Polymers

PSA polymers were prepared according to Examples 1 and 4. The PSA polymers prepared using K₂CrO₄ were used to remove Pb(II) and Hg(II) from Pb(NO₃)₂ or Hg(NO₃)₂ solution according to the procedure described in Example 7. After adsorption, the PSA polymers containing the adsorbed metal ions were filtered from the solution and prepared for examination for their IR spectra.

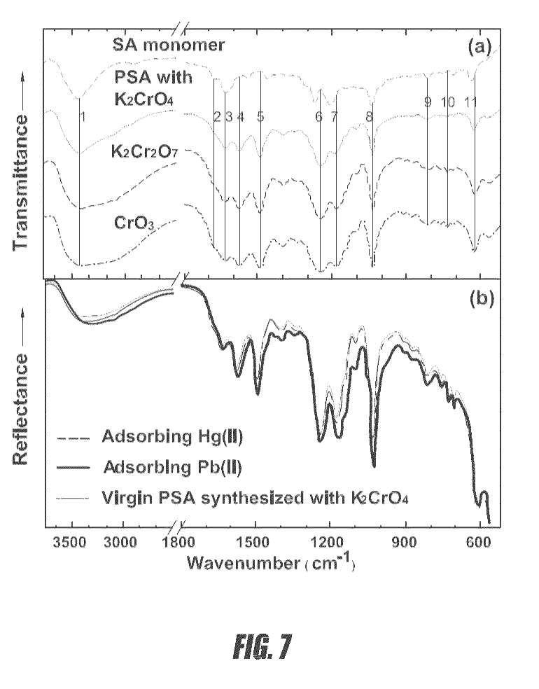

IR spectra for monomeric SA and the as-grown PSAs were recorded on a Bruker Equinox 55/Hyperion 2000 FT-IR spectrometer with a resolution of <0.5 cm⁻¹, a wavenumber precision of better than 0.01 cm⁻¹, and a signal/noise ratio of >3600:1 by transmittance and ATR methods. The results are shown in FIG. 7. The main IR bands and possible IR absorbance assignments of the monomeric SA and the PSA polymers synthesized with K₂CrO₄ as the oxidant are summarized in Table 9.

TABLE 9
Summary of Main IR bands and Possible IR Absorbance Assignments

| | Possible | | |
|---|---|---|---|
| No | assignments | Monomeric SA | PSA polymers |
| 1 | N—H stretch | 3430 (broad, strong) | 3410 (strong, |
| | | | very broad) |
| 2, 3 | C═O (quinone) | 1680 (weak), | 1640 (moderate) |
| | | 1630 (strong) | |
| 4 | C═C | 1540 (weak) | 1580 (strong, |
| | | | qunoid) |
| 5 | C═C | 1460 (weak) | 1490 (strong, |
| | | | benzenoid) |
| 6 | C—N stretch | 1270 (strong) | 1250 (strongest) and |
| | | | dopant Cr₂O₇²⁻ |
| 7 | O═S═O | 1210 (very strong) | 1190 (strong) |
| | asymmetrical stretch | | |
| 8 | O═S═O | 1040 (strongest) | 1040 (strong, sharp) |
| | symmetrical stretch | | |
| 9, 10 | C—H out-of-plane | 816, 712 (weak) | 822, 737 (very |
| | bend | | weak) |
| 11 | S—O stretch | 636 (moderate) | 627 (moderate) |

The assignments shown in Table 2 demonstrates that the PSA polymers are polymerized mainly at 1,4 positions through a bonding manner of head-to-tail structure in an electroactive polyaniline. The large difference between the IR spectra of the SA monomer and the PSA polymer shown in this example demonstrates that the PSA polymers are real polymers rather than simple chelates or mixture of monomers with some oligomers.

### Example 9

### Wide-Angle X-Ray Diffraction

PSA polymers were prepared according to Example 1. The PSA polymers prepared using K₂CrO₄ were used to remove Pb(II) and Hg(II) from Pb(NO₃)₂ or Hg(NO₃)₂ solution according to the procedure described in Example 7. After adsorption, the PSA polymers containing the adsorbed metal ions were filtered from the solution and prepared for evaluation under X-ray diffraction

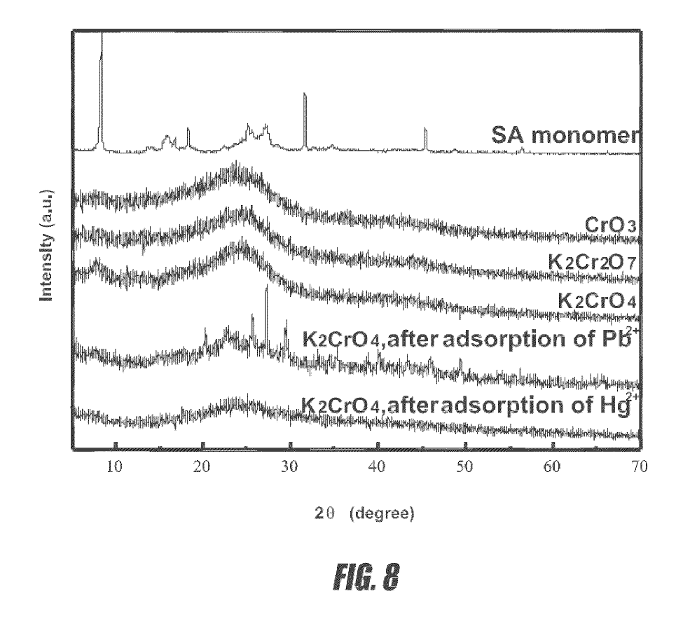

Wide-angle X-ray diffraction (WAXD) was performed with a D/max2550VB3+/PC X-ray diffractometer with CuK_{α} radiation at a scanning rate of 100 min⁻¹. The wide-angle X-ray diffractograms are shown in FIG. 8.

The large difference between the X-ray diffraction of the SA monomer and that of the PSA polymers further demonstrates that PSA polymers are genuine polymers.

### Example 10

### Adsorption of Metal Ions

PSA polymer powders were prepared using K₂CrO₄ as the oxidant according to the procedure described in Example 1. Those PSA polymers were evaluated for their adsorbility of Pb(II), Hg(II), Cd(II), Cu(II), Fe(III), and Zn(II). The PSA polymers were incubated with 25 mL 200 mg L⁻¹ Pb(NO₃)₂, Hg(NO₃)₂, CdSO₄, CuSO₄, FeCl₃ or ZnSO₄ solution at 30° C. for 1 hour without ultrasonic treatment. The PSA dosage was 2 g L⁻¹. The concentration of various metal ions of the solution before and after incubating with the PSA polymers was determined according to the procedure described in Example 7. The adsorption results are shown in Table 10.

TABLE 10
Adsorption Capacity and Adsorptivity of Six Metal Ions

| | | | | | | | | Conductivity |
|---|---|---|---|---|---|---|---|---|
| | | | | | | | | of PSA |
| | | | Metal Ion | Metal Ion | | | | polymer after |
| Metal | [Initial | [Final metal | adsorption | Adsorptivity | Theoretical selectivity | | | ion |
| ion | Metal ion] | ion] | capacity Qₜ | (percentage | coefficient | | | adsorption |
| solutions | (mg L⁻¹) | (mg L⁻¹) | (mg g⁻¹) | reduction) | Hg(II) | Pb(II) | Cd(II) | (S cm⁻¹) |
| HgNO₃ | 200 | 15.2 | 92.4 | 92.4 | 1.00 | 0.96 | 0.94 | 5.85 × 10⁻⁷ |
| PbNO₃ | 200 | 22.0 | 89.0 | 89.0 | 1.04 | 1.00 | 0.98 | 4.18 × 10⁻⁷ |
| CdSO₄ | 200 | 25.0 | 87.5 | 87.5 | 1.06 | 1.02 | 1.00 | 4.35 × 10⁻⁷ |
| CuSO₄ | 200 | 143.4 | 28.3 | 28.3 | 3.27 | 3.14 | 3.08 | 1.26 × 10⁻⁷ |
| FeCl₃ | 200 | 169.8 | 15.1 | 15.1 | 6.12 | 5.89 | 5.79 | 1.10 × 10⁻⁷ |
| ZnSO₄ | 200 | 180.8 | 9.6 | 9.6 | 9.63 | 9.27 | 9.11 | 9.77 × 10⁻⁸ |

This example demonstrates that the PSA polymers are efficient and effective adsorbent for various types of metal ions.

### Example 11

### Competitive Adsorption of Metal Ions

In this example, mixed ion solutions containing Pb(II) and Hg(II), as well as several other types of metal ions, were used to evaluate the selective adsorptivity of PSA polymers for Pb(II) and Hg(II) in the presence of other metal ions. PSA polymer powders were prepared using K₂CrO₄ as the oxidant according to the procedure described in Example 1. In one experiment, 50 mg PSA polymer powders were incubated with 25 mL mixed solution I with Pb(NO₃)₂, Hg(NO₃)₂, Cu(NO₃)₂, FeCl₃, and Zn(NO₃)₂ at 30° C. for 1 hour without ultrasonic treatment. The ion concentration for each of the Hg(II), Pb(II), Cu(II), Fe(III), and Zn(II) ions in mixed solution I was 20 mg L⁻¹. In another experiment, 50 mg PSA polymer powders were incubated with 25 mL mixed solution II with Pb(NO₃)₂, Hg(NO₃)₂, AgNO₃, Cu(NO₃)₂, and Zn(NO₃)₂ at 30° C. for 1 hour without ultrasonic treatment. The ion concentration for each of the Hg(II), Pb(II), Cu(II), Ag(I), and Zn(II) ions in mixed solution II was 20 mg L⁻¹. The concentration of various metal ions of the solution before and after incubating with the PSA polymers was determined according to the procedure described in Example 7. The adsorption results are shown in Table 11.

TABLE 11
Competitive Adsorption of Six Metal Ions

| | | | | | Adsorptivity | | |
|---|---|---|---|---|---|---|---|
| | | | [Final metal ion] | | (percentage | | |
| | | [Initial | (mg L⁻¹) | | reduction) | | Difference |
| Mixed | Metal | Metal ion] | Separated | Mixed | Separated | Mixed | in % |
| solution | ions | (mg L⁻¹) | solution | solution | solution | solution | adsorptivity |
| Hg(NO₃)₂ | Hg(II) | 20 | 0.04 | 0.18 | 99.8 | 99.1 | −0.7 |
| Pb(NO₃)₂ | Pb(II) | 20 | 0.06 | 0.44 | 99.7 | 97.8 | −1.9 |
| Cu(NO₃)₂ | Cu(II) | 20 | 4.12 | 6.30 | 79.4 | 68.5 | −10.9 |
| FeCl₃ | Fe(III) | 20 | 14.02 | 15.14 | 29.9 | 24.3 | −5.6 |
| Zn(NO₃)₂ | Zn(II) | 20 | 14.88 | 15.58 | 25.6 | 22.1 | −3.5 |
| Hg(NO₃)₂ | Hg(II) | 20 | 0.04 | 0.14 | 99.8 | 99.3 | −0.5 |
| Pb(NO₃)₂ | Pb(II) | 20 | 0.06 | 0.30 | 99.7 | 98.5 | −1.2 |
| AgNO₃ | Ag(I) | 20 | 1.04 | 2.66 | 94.8 | 86.7 | −8.1 |
| Cu(NO₃)₂ | Cu(II) | 20 | 4.12 | 5.84 | 79.4 | 70.8 | −8.6 |
| Zn(NO₃)₂ | Zn(II) | 20 | 14.88 | 12.28 | 25.6 | 38.6 | 13.0 |

As shown in Table 11, the adsorptivity of each metal ion in the mixed ion solution was slightly lower than that in its pure solution, likely due to the interference from other metal ions in the mixed solution. Despite the presence of other interfering metal ions, the adsorbability of the PSA polymers for Hg(II) and Pb(II) were still well above 97%. This example demonstrates that the PSA polymers are superior adsorbent for mercury and lead ions.

### Example 12

### Purification of Ambient Wastewater

PSA polymer powders were prepared using K₂CrO₄ as the oxidant according to the procedure described in Example 1. The concentration of Pb(II), Cu(II), Fe(III), and Zn(II) in ambient wastewater before and after purification by the PSA polymers was determined using ICP analysis. The adsorption results are summarized in Table 12.

TABLE 12
Summary of Metal Ion Removal Efficiency

| | | After 1^{st} adsorption | |
|---|---|---|---|
| Metal | Concentration in polluted | Concentration | |
| ions | river (mg L⁻¹) | (mg L⁻¹) | Adsorptivity (%) |
| Pb(II) | 0.4242 | <<0.025 | >>94.1 |
| Cu(II) | 0.1385 | 0.0831 | 40.0 |
| Fe(III) | 0.1919 | 0.1825 | 4.90 |
| Zn(II) | 0.0134 | 0.0133 | 0.746 |
| | | After 1^{st}/2^{nd} adsorption | |
| | Concentration in printery | Concentration | |
| | wastewater (mg L⁻¹) | (mg L⁻¹) | Adsorptivity (%) |
| Pb(II) | 6.796 | <0.025/<0.025 | >99.6/>99.6 |
| Cu(II) | 0.0490 | 0.0442/0.0415 | 9.80/15.3 |
| Fe(III) | 0.1736 | 0.1642/0.1602 | 5.41/7.72 |
| Zn(II) | 0.5838 | 0.5811/0.5806 | 0.462/0.548 |

This example demonstrates that the PSA polymers can be used to remove various metal ions from polluted environmental and industrial wastewaters.

### Example 13

### Desorption of Metal Ions

PSA polymer powders were prepared according to Example 1. Those PSA polymer powders was used to adsorb Pb(II) from an aqueous sample in a general procedure as described in Example 7. Pb(II)-adsorbing PSA polymer powders was then filtered out and recovered. 50 mg of the Pb(II)-adsorbing PSA polymer powders was placed into 50-mL conical flask, and 15 mL 2.5 M HNO₃ was poured into the flask as an eluant. The mixture was stirred for 30 minutes at 30° C. to make the bound Pb(II) ions release into the eluant. After that the pH value of the Pb(II) desorption solution was adjusted to be close to 6 by solid NaOH, the Pb(II) desorption solution was added with 6 mL hexamethylene tetramine buffer solution and one drop of 0.5% xylenol orange indicator. The concentration of the desorbed lead ion in the aqueous phase was determined by EDTA complex titration method. It was determined that 93.6% of the adsorbed Pb(II) ion was released into the eluant, demonstrating that PSA polymers can be regenerated and reusable as adsorbent for metal ions.

What is claimed is:

1. A polymer comprising at least one monomer unit selected from the group consisting of a first monomer unit represented by Formula I, a second monomer unit represented by Formula II, and a third monomer unit represented by Formula III: 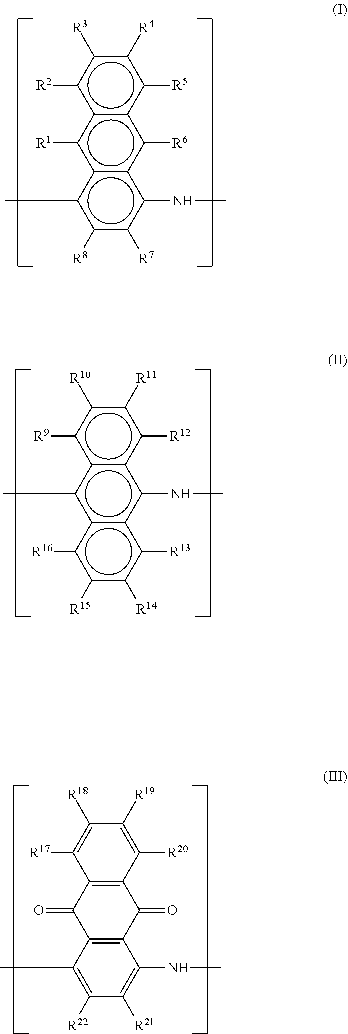
wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;
wherein R⁹, R¹⁰, R¹¹, R¹², R³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;
wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;
wherein at least one of R¹⁷, R¹⁸, R¹⁹, R²⁰, R²¹, and R²² is X;
wherein each X is independently selected from the group consisting of —SO₃H, —SO₃NH₄, —SO₃Na, and —SO₃K.

2. The polymer of claim 1, wherein R¹, R², R³, R⁴, R⁵, R⁶, R⁷, R⁸, R⁹ and R¹⁰ are each independently selected from the group consisting of hydrogen, —NH—CH₃, —NH—CH₂CH₃, —NH—OH, —N═O, —N═CH₂, —N(CH₃)₂, —N═CH—CH₃, —N═NH, —NH₂, ═O, and —SO₃H.

3. The polymer of any one of claims 1-2, wherein the halogen is —Cl or —Br.

4. The polymer of any one of claims 1-3, wherein R¹ and R⁶ are each ═O.

5. The polymer of claim 4, wherein R⁷ and R¹¹ are each independently —NH₂ or hydrogen.

6. The polymer of claim 5, wherein R³, R⁴, R⁵ and R⁹ are each hydrogen.

7. The polymer of claim 6, wherein R² and R⁸ are each independently selected from the group consisting of hydrogen, —SO₃NH₄, —SO₃Na, —SO₃K and —SO₃H.

8. The polymer of claim 7, wherein the monomer unit is selected from the group consisting of

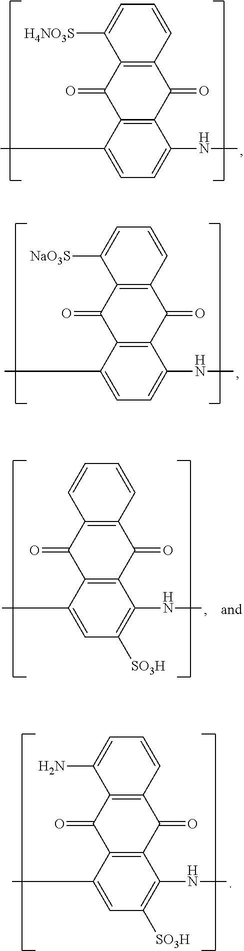

9. The polymer of claim 7, wherein the monomer unit is

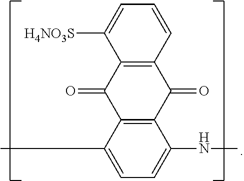

10. The polymer of any one of claims 1-3, wherein R¹ and R⁶ are each independently —NH₂ or hydrogen.

11. A composition comprising nanoparticles, wherein the nanoparticles comprise a polymer comprising at least one monomer unit selected from the group consisting of a first monomer unit represented by Formula I, a second monomer unit represented by Formula II, and a third monomer unit represented by Formula III: 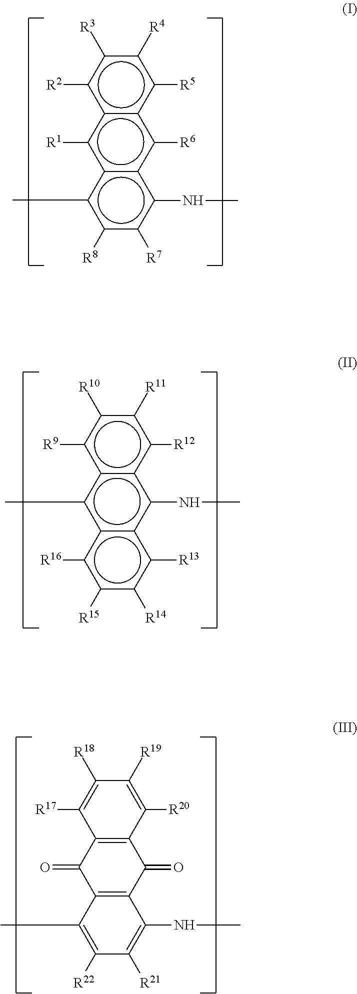
wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;
wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;
wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;
wherein at least one of R¹⁷, R¹⁸, R¹⁹, R²⁰, R²¹, and R²² is X;
wherein each X is independently selected from the group consisting of —SO₃H, —SO₃NH₄, —SO₃Na, and —SO₃K.

12. The nanoparticles of claim 11, wherein the nanoparticles have a size of about nm to about 200 nm.

13. The nanoparticles of any one of claims 11-12, wherein the nanoparticles have an apparent density of about 0.2 g/cm³ to about 1.0 g/cm³.

14. The nanoparticles of any one of claims 11-13, wherein the nanoparticles have a bulk density of about 0.3 g/cm³ to about 1.0 g/cm³.

15. The nanoparticles of any one of claims 11-14, wherein the nanoparticles have an average BET specific area of about 15 m²/g to about 1000 m²/g.

16. The nanoparticles of any one of claims 11-15, wherein the nanoparticles have an average pore diameter of about 10 nm to about 50 nm.

17. A method of making a polymer, the method comprising:
forming a composition comprising at least one oxidizing agent and at least one monomer represented by a structure selected from the group consisting of Formula IV, Formula V and Formula VI: 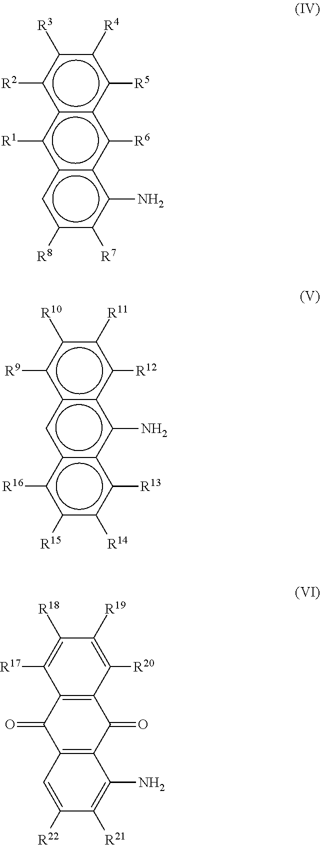
wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;
wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;
wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;
wherein at least one of R¹⁷, R¹⁸, R¹⁹, R²⁰, R²¹, and R²² is X;
wherein each X is independently selected from the group consisting of —SO₃H, —SO₃NH₄, —SO₃Na, and —SO₃K; and
maintaining the composition under conditions effective to polymerize the monomer to form the polymer.

18. The method of claim 17, wherein the monomer is selected from the group consisting of 5-sulfo-1-aminoanthraquinone (SA), 1-aminoanthraquinone-5-sulphonic acid sodium salt, 1-aminoanthraquinone-2-sulphonic acid, 1,5-diaminoanthraquinone-2-sulphonic acid, and combinations thereof.

19. The method of any one of claims 17-18, wherein the oxidizing agent is soluble in water.

20. The method of any one of claims 17-19, wherein the oxidizing agent is CrO₃, K₂Cr₂O₇, K₂CrO₄, or any combination thereof.

21. A method for removing a metal ion from a sample, the method comprising:
providing an untreated sample suspected of containing the metal ion; and
contacting the sample and a composition to form a treated sample, wherein the composition comprises a polymer comprising a monomer unit represented by a formula selected from Formula I, Formula II and Formula III: 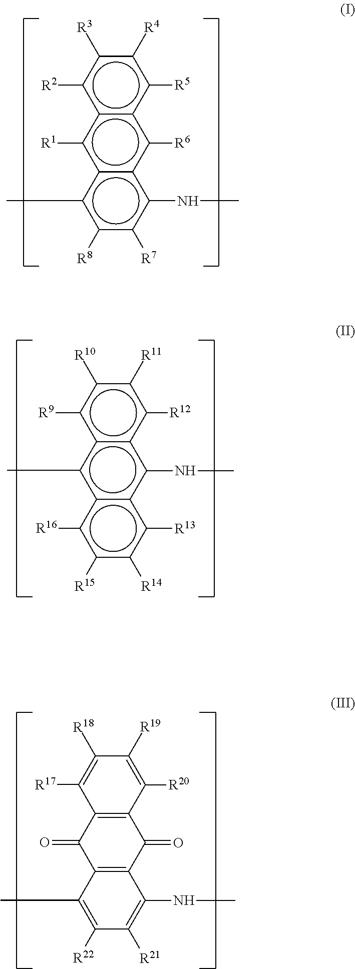
wherein R¹, R², R³, R⁴, R⁵, R⁶, R⁷, and R⁸ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R¹, R², R³, R⁴, R⁵, R⁶, R⁷, and R⁸ are ═O, and at least one of R¹, R², R³, R⁴, R⁵, R⁶, R⁷, and R⁸ is X;
wherein R⁹, R¹⁰, R¹¹, R¹², R¹³, R¹⁴, R¹⁵, and R¹⁶ are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, ═O, —OCH₃, —OH, —SH, halogen, C₁₋₆alkyl, and X;
wherein at least two of R⁹, R¹⁰, R¹¹, R¹², R¹³, R¹⁴, R¹⁵, and R¹⁶ are ═O, and at least one of R⁹, R¹⁰, R¹¹, R¹², R¹³, R¹⁴, R¹⁵, and R¹⁶ is X;
wherein R¹⁷, R¹⁸, R¹⁹, R²⁰, R²¹, and R²² are each independently selected from the group consisting of hydrogen, —N═O, —N═CH₂, —N(CH₃)₂, —N═CH—CH₃, —N═NH, —NH—CH₃, —NH—CH₂CH₃, —NH—OH, —NH₂, —OCH₃, —OH, —SH, halogen, C₁₋₆alkyl, and X;
wherein at least one of R¹⁷, R¹⁸, R¹⁹, R²⁰, R²¹, and R²² is X;
wherein each X is independently selected from the group consisting of —SO₃H, —SO₃NH₄, —SO₃Na, and —SO₃K.

22. The method of claim 21, wherein the monomer unit is selected from the group consisting of

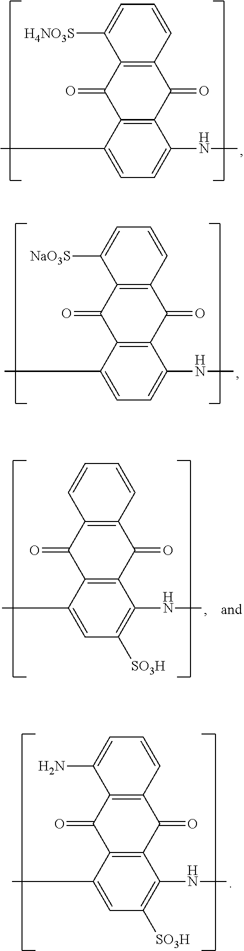

23. The method of claim 22 wherein the monomer unit is

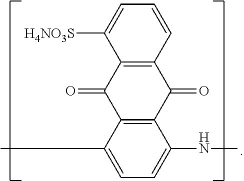

24. The method of any one of claims 21-23, wherein the metal ion is a heavy metal ion.

25. The method of claim 24, wherein the heavy metal ion is selected from the group consisting of As(III), As(V), Cd(II), Cr(VI), Pb(II), Hg(II), Sb(III), Sb(V), Ni(II), Ag(I) and Tl(III).

26. The method of any one of claims 21-23, wherein the metal ion is a noble metal ion.

27. The method of claim 26, wherein the noble metal ion is selected from the group consisting of Ag(I), Au(I), Au(III), Pt(II), Pt(IV), Ir(III), Ir(IV), Ir(VI), Pd(II) and Pd(IV).

28. The method of any one of claims 21-27, wherein the untreated sample is wastewater.

29. The method of any one of claims 21-28, wherein the concentration of the metal ion in the untreated sample is no more than about 5 g/L.

30. The method of claim 29, wherein the concentration of the metal ion is from about 0.01 mg/L to about 1 g/L.

31. The method of any one of claims 21-30, wherein the untreated sample has a higher concentration of the metal ion than the treated sample.

32. The method of claim 31, wherein the concentration of the metal ion in the untreated sample is at least about 5 times higher than the concentration of the metal ion in the treated sample.

33. The method of claim 32, wherein the concentration of the metal ion in the untreated sample is at least about 10 times higher than the concentration of the metal ion in the treated sample.

34. The method of claim 33, wherein the concentration of the metal ion in the untreated sample is at least about 20 times higher than the concentration of the metal ion in the treated sample.

35. The method of any one of claims 21-30, wherein the concentration of the metal ion in the treated sample is less than about 20% of the concentration of the metal ion in the untreated sample.

36. The method of claim 35, wherein the concentration of the metal ion in the treated sample is less than about 5% of the concentration of the metal ion in the untreated sample.

37. The method of claim 36, wherein the concentration of the metal ion in the treated sample is less than about 1% of the concentration of the metal ion in the untreated sample.
